(19) United States
(12) Patent Application Publication
(10) Pub. No.: US 2004/0096267 A1
(43) Pub. Date: May 20, 2004

(54) Connector

(76) Inventor: Martin C. Voves III, San Lorenzo, CA (US)

Correspondence Address: Bruce H. Johnsonbaugh, Eckhoff & Hoppe, 333 Sacramento Street, San Francisco, CA, 94111, US

(21) Appl. No.: 10/300,152

(22) Filed: Nov. 19, 2002

(51) Int. Cl. F16B 1/00

(52) U.S. Cl. 403/229

(57) ABSTRACT

An art and craft connector is provided for holding first and second rigid panels in a fixed but modifiable relationship to each other. The connector in one form includes a single length of carbon steel wire having a first segment formed into two adjacent and concentric loops, a second segment formed into two adjacent and concentric loops and an interconnecting length of wire between the first and second segments for holding the segments in a fixed but modifiable relationship. The interconnecting length of material can simply be bent by the user to change the angular relationship of the panels supported by the connector. Any number of panels can be connected together utilizing multiple connectors of the present invention. The panels can be arranged in any configuration, limited only by the creativity of the user. Each connector may have additional loops to provide three and four way connectors, and also more than four way connectors.

### BACKGROUND AND BRIEF SUMMARY OF INVENTION

The present invention relates to a connector usable in a variety of arts and crafts. More particularly, the present invention provides a connector for supporting rigid panels in fixed, but modifiable, positions. The connector is easily bendable so that the rigid panels may be held in any desired angular relationship to each other.

Art and craft enthusiasts are constantly seeking new, sturdy, cost effective and easy to use connectors. The present invention provides an easy to use, inexpensive and sturdy connector usable by persons of all ages. The preferred form of the invention uses carbon steel wire formed into a pair of double, concentric and adjacent loops (i.e., a total of four loops) to hold two rigid panels. Each panel simply slides between two adjacent and concentric loops. Additional loops may be provided so that a single connector can support three or more panels.

The prior art includes a variety of fasteners and paper clip designs. For example, the Schultz et al U.S. Pat. No. 5,806,149 teaches a bent wire spring clip. However, Schultz does not teach or suggest the use of a pair of double, concentric loops for holding rigid panels. Schultz discloses the use of several single, non-concentric loops of wire to perform various clip functions In contrast, the present invention utilizes a pair (or more) of double, concentric loops wherein each double loop performs a resilient grasping and holding function, i.e., the panel is slid into position between the two concentric loops. The purpose of using a pair (or more) of double, concentric loops in the present invention is to provide for the support of two or more panels in an angular relationship to each other.

Multi-purpose paperclips, such as shown in the Crespo Fuster U.S. Pat. No. 6,163,934, are also known in the art. Crespo Fuster uses a pair of non-concentric single loops and utilizes the mutually crossing portion of the loops to connect a stack of flat sheets of material together. The present invention differs from Crespo Fuster in that it uses a pair (or more) of double, concentric loops and wherein each of the double, concentric loops is utilized to grasp and support a rigid panel. The two double loops are joined by a bendable and resilient piece of material which allows the user to vary the orientation of panels held by each double loop.

The prior art also includes the McCaffrey U.S. Pat. No. 3,474,555 which teaches a display card holder having a double loop of wire for supporting a single panel. In contrast, the present invention utilizes two or more double loops (i.e., a total of four loops) to adjustably hold two or more panels. McCaffrey is unable to support two panels in an angular relationship to each other.

The present invention provides a simple yet effective and reliable connector for use in arts and crafts, wherein the connector supports two or more rigid panels in angular relationship to each other. The connector is readily bendable to vary the orientation of the rigid panels supported by the connector. Multiple connectors may be used to connect multiple panels in a virtually unlimited number of various configurations. The connector is sturdy, inexpensive and its use is intuitive. It is ideal for use in arts and crafts.

A primary object of the invention is to provide a connector primarily for use in arts and crafts capable of holding two or more rigid panels in angular relationship to each other.

A further object of the invention is to provide a connector which is readily bendable by the user to modify or vary the angular relationship between two or more rigid panels supported by the connector.

Another object of the invention is to provide a very sturdy, economical connector for use in various arts and crafts wherein the use of the connector is intuitive and extremely easy to use.

Other objects and advantages will become apparent from the following description and the drawings wherein:

### BRIEF DESCRIPTION OF THE DRAWINGS

FIG. 1 is a perspective view of one embodiment of the present invention;

FIG. 2 is a perspective view of the connector shown in FIG. 1 as used to hold and support two rigid panels;

FIG. 3 is a plan view of the connector shown in FIG. 1 which has been bent so that it will support rigid panels at a 90° angle;

FIG. 4 is a perspective view showing two panels supported by the connector of FIG. 3 after the connector is bent to a 45° angle;

FIG. 5 is a perspective view of a second embodiment of the invention having an elongated stem between the holding elements of the connector;

FIG. 6 is a perspective view showing the connector of FIG. 5 supporting two rigid panels in parallel, spaced apart planes;

FIG. 7 is a perspective view showing the connector and panels of FIG. 6 wherein the connector has been bent to change the angular displacement between the supported panels;

FIG. 8 is a further embodiment of the invention showing an elliptical design of each loop;

FIG. 9 illustrates a perspective view of yet another embodiment of the invention utilizing a generally squared configuration of each loop;

FIG. 10A is a sectional view on the line 10A-10A of FIG. 1;

FIG. 10B is a sectional view showing an alternate pattern of adjacent loops;

FIG. 10C is a sectional view showing yet another configuration of adjacent loops;

FIG. 11 is a plan view of a three way connector of the present invention; and

FIG. 12 is a plan view of a four way connector to the present invention.

### DETAILED DESCRIPTION OF THE INVENTION

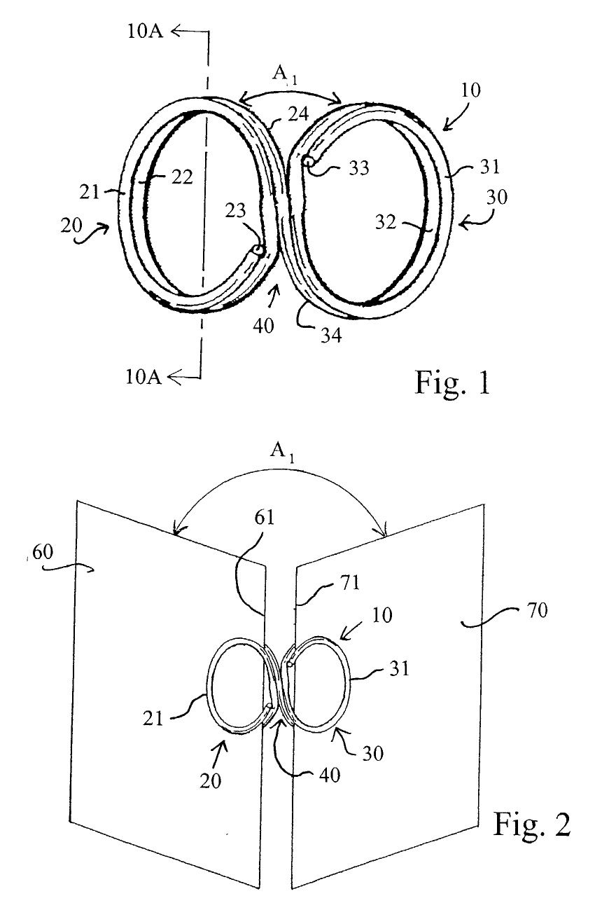

FIGS. 1 and 2 illustrate a first embodiment of the invention wherein the connector is shown generally as 10 and includes a first segment 20 of resilient material formed into two adjacent and concentric loops 21 and 22. A second segment shown as 30 of resilient material, such as carbon steel wire, is formed into two adjacent and concentric loops 31 and 32. An interconnecting length of resilient material 40 is between the first and second segments 20, 30 for holding the segments 20 and 30 in a fixed angular relationship A₁. In the preferred embodiment shown in FIG. 1, the connector is formed from a single length of carbon steel wire. The connector 10 has a total of four loops, two of which are utilized to hold a first panel and the other two of which are utilized to hold a second panel. The first segment 20 is a helical coil and extends angularly from tip 23 through approximately 630° to a point 24 at which the interconnecting length begins. Similarly, second segment 30 is a helical coil and extends from its tip end 33 through an arc of approximately 630° to point 34 at which it begins to form a portion of the interconnecting length of resilient material 40. The preferred angular length of first and second segments 20 and 30, respectively, is between 540° and 720°. It is within the scope of the invention to use more than a double loop, i.e, angular lengths exceeding 720°, such as a triple loop of 1080°, etc.

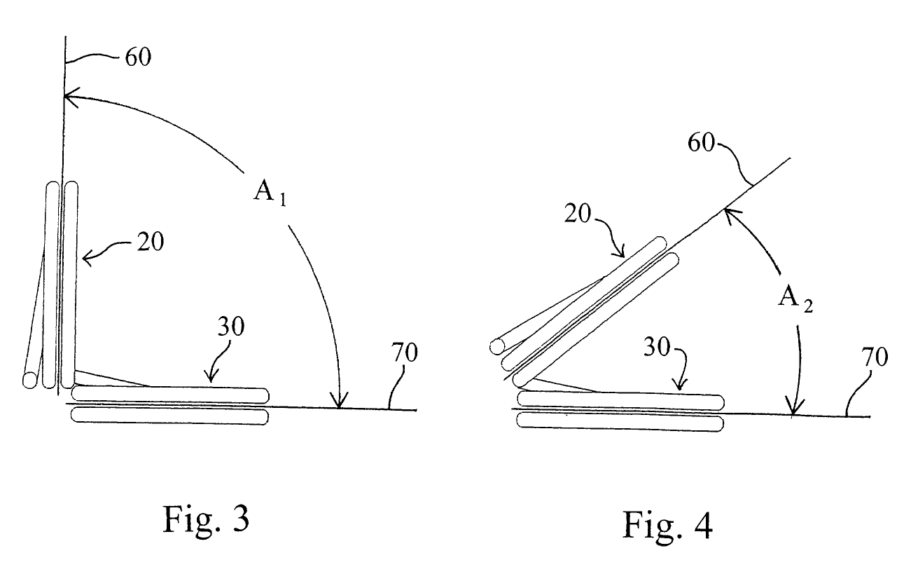

FIG. 2 illustrates connector 10 supporting first and second rigid panels 60 and 70. Panels 60 and 70 are rigid sheet material such as plastic, cardboard, heavy paper, metal or other such rigid sheet material. Panels 60 and 70 may have different thicknesses. Panel 60 is supported by first segment 20 Edge 61 of panel 60 is simply inserted between loops 21 and 22 from any direction. Loops 21 and 22 serve to grasp and hold the panel firmly in position shown in FIG. 2 Similarly, panel 70 is connected to second segment 30 by having the edge 71 slid between loops 31 and 32 of second segment 30. FIGS. 3 and 4 illustrate how the connector 10 illustrated in FIGS. 1 and 2 may simply be bent, thereby causing a change in the angular relationship between panels 60 and 70. For example, the angle A₁ illustrated in FIGS. 1, 2 and 3 is 90° whereas the angle A₂ illustrated in FIG. 4 is 45°. The user simply bends segments 20 and 30 toward each other, which causes a bend to occur in the interconnecting length of resilient material 40. The user may bend segments 20 and 30 to form any desired angle between 0 and 360°.

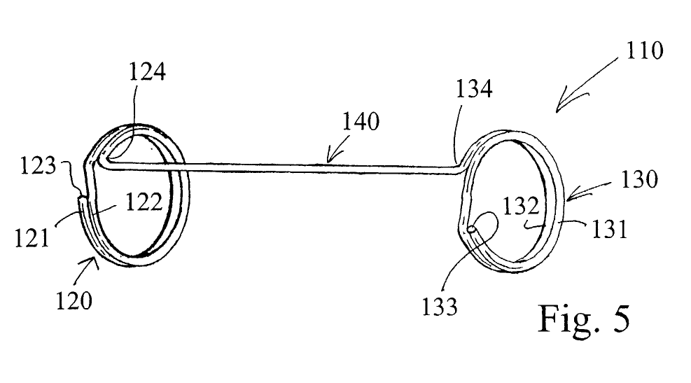

FIG. 5 illustrates an alternate form of the invention wherein the first segment 120 is connected to the second segment 130 by an elongated stem 140. Segment 120 includes first and second loops 121, 122 and second segment includes first and second loops 131, 132. The loops 121 and 122 are adjacent and concentric as is the case with the loops 131 and 132. The first segment is a helical coil and extends angularly from its outer tip or extremity 123 to a point 124 on first segment 120 at which a transition is made to the interconnecting length of resilient material 140. This angular distance between tip 123 and point 124 is approximately 630° but may range from 540° to approximately 720°. Second segment 130 similarly is a helical coil and extends through an angular path from its extreme outer tip 133 to point 134 on segment 130 where a transition is made to the interconnecting length of material 140. This arc or angular path between tip 133 and point 134 ranges between 540° and 720° but as shown in FIG. 5 is approximately 630°.

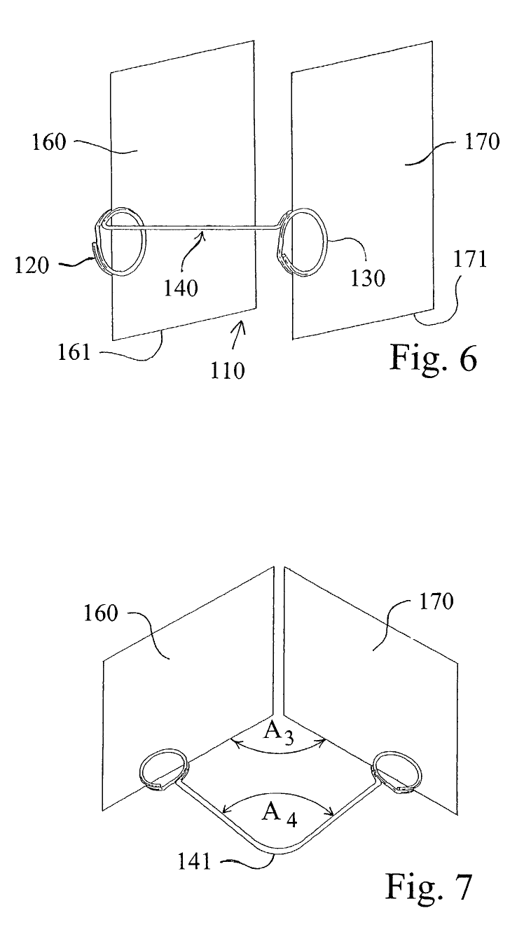

FIGS. 6 and 7 illustrate connector 110 being used to support first and second rigid panels 160 and 170 in a fixed but modifiable relationship. As shown in FIG. 6, panels 160 and 170 lie in parallel but spaced apart planes. Panel 160 is supported between loops 121 and 122 and has a lower edge 161 which simply slides between loops 121 and 122. Similarly, panel 170 has a lower edge 171 which simply slips through loops 131 and 132 of segment 130. As shown in FIG. 6, the interconnecting length of bendable and resilient material 140 between first segment and second segment 130 may easily be bent as shown in FIG. 7 to change the angular relationship of panels 160 and 170. In FIG. 7 the interconnecting length of material has been bent near its middle at point 141 to create an angle A₃ between first panel 160 and second panel 170 of approximately 90°. This is accomplished by bending the elongated stem from its straight position shown in FIG. 6 to a position wherein it forms an angle A₄ of approximately 90°.

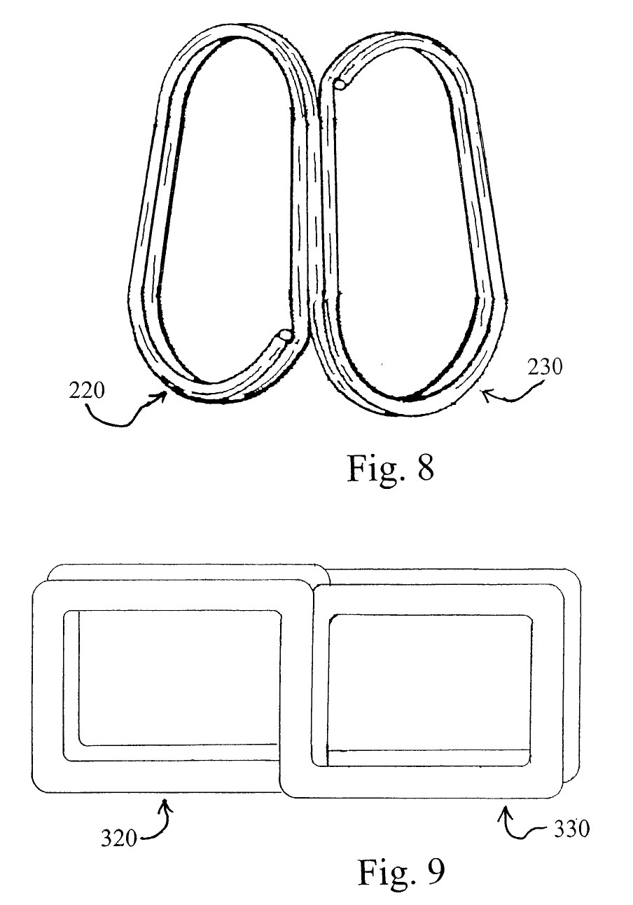

FIG. 8 shows a perspective view of a further embodiment of the invention wherein the loops forming first and second segments 220 and 230 are elliptical in design rather than circular as shown in FIGS. 1-7. In all other respects, the embodiment shown in FIG. 8 is the same as that illustrated in FIGS. 1-7.

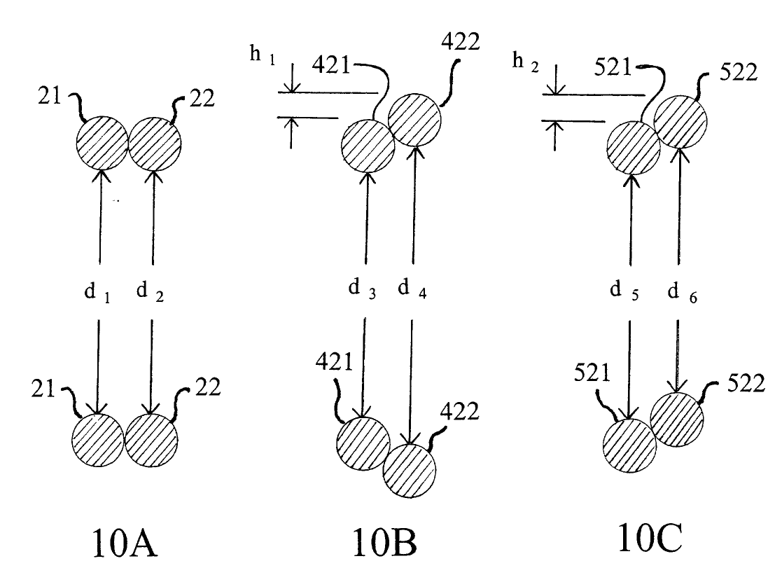

FIG. 9 is a perspective view of yet another embodiment of the invention wherein each of the loops forming the segments 320 and 330 are generally squared off shapes but formed of carbon steel wire. The different shapes used in FIGS. 8 and 9 may be preferred by some arts and crafts people and may have advantages for various particular applications.

FIG. 10A is a section on the line 10A-10A of FIG. 1 and illustrates how loops 21 and 22 are concentric circles which are adjacent each other. Loops 21 and 22 have inner diameters d₁ and d₂ which are equal. It is also within the scope of the invention to provide loops such as shown in FIGS. 10B and 10C As shown in FIG. 10B, loop 421 has a slightly smaller inner diameter d₃ than the inner diameter d₄ of adjacent loop 422. This results in an offset between loops 421, 422 of a distance h₁. As shown in FIG. 10C, loop 521 has the same inner diameter d₅ as the inner diameter d₆ adjacent loop 522 but is offset a distance h₂ relative to loop 522. As used herein and in the claims, the term “concentric” is used in a broad sense to include the configurations shown in FIGS. 10A, 10B and 10C The term “concentric” as used herein and in the claims is also used in a broad sense to describe adjacent elliptical loops as shown in FIG. 8 as well as squared off adjacent loops illustrated in FIG. 9.

The term “adjacent,” as used herein and in the claims, is used in a broad sense to include loops that contact each other as well as loops that are slightly spaced apart. The spacing of the loops may be somewhat greater, i.e., 0.005 to 0.030 inch (or even greater) to accommodate thicker panels The loops may be formed of thicker wire or other resilient material to provide a greater grasping and holding force. The loops may be coated with plastic or other material.

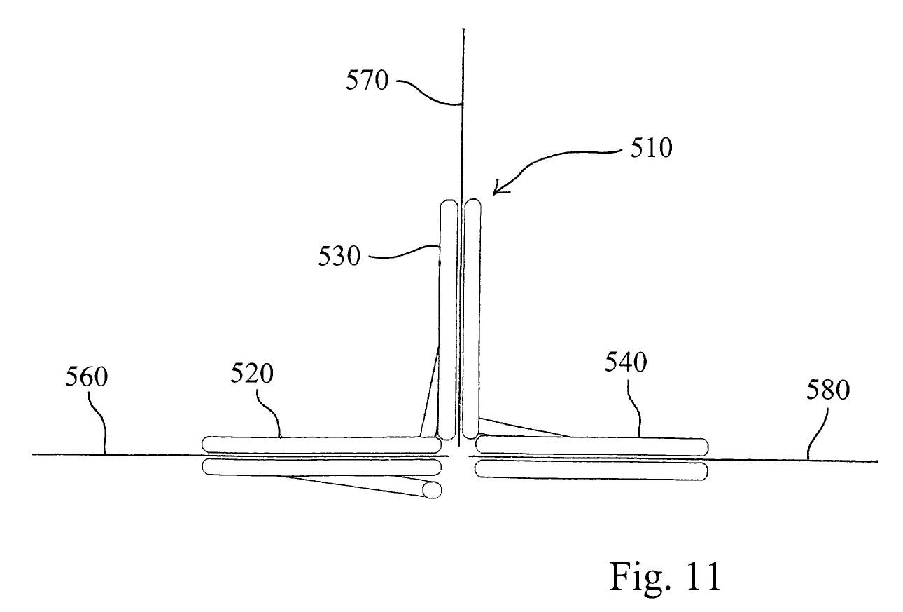

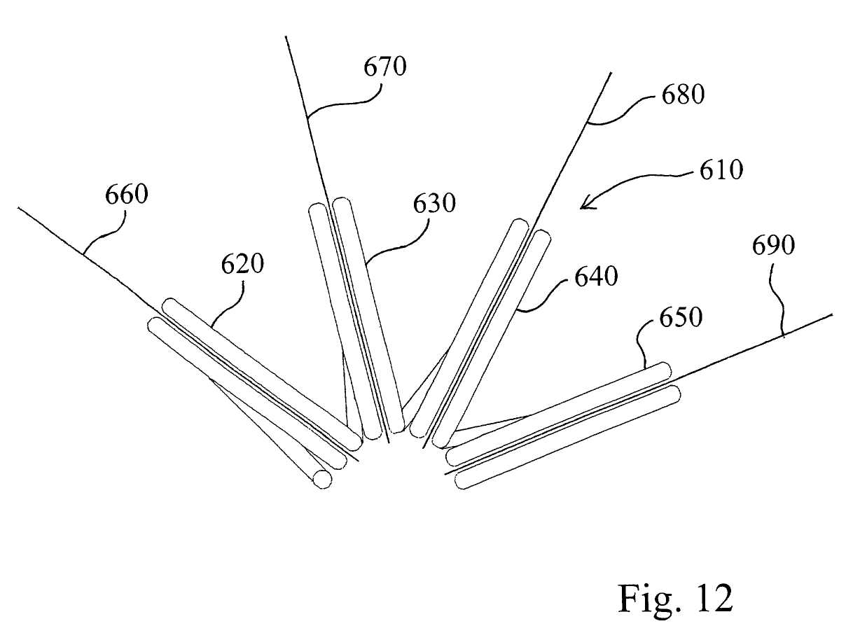

FIG. 11 illustrates an alternate embodiment wherein three way connector 510 includes three segments 520, 530 and 540 for holding three rigid panels 560, 570 and 580, respectively. Panels 560 and 580 each form 90° angles with panel 570. Those angles are readily adjustable as described above.

FIG. 12 illustrates a four way connector 610 having four segments 620, 630, 640 and 650 for holding four separate panels 660, 670, 680 and 690, respectively. The angles between adjacent segments are quickly adjustable.

It is also within the scope of the invention to provide more than four segments in a single connector for supporting more than four panels. A number of n segments may be provided in a single connector for supporting n separate panels, where n is greater than one.

Multiple connectors may be placed between two panels. Furthermore, complex structures using many panels and connectors may be created, limited only by the creativity of the user. The invention provides a user with a device for connecting a sheet to other sheets in a variety of ways quickly by hand and offers new creative possibilities for “3D sketching,” model making, sculpture, toy construction kits, craft, art projects, human scale and numerous special applications.

The foregoing description of the invention has been presented for purposes of illustration and description and is not intended to be exhaustive or to limit the invention to the precise form disclosed. Modifications and variations are possible in light of the above teaching. The embodiments were chosen and described to best explain the principles of the invention and its practical application to thereby enable others skilled in the art to best use the invention in various embodiments and with various modifications suited to the particular use contemplated. The scope of the invention is to be defined by the following claims.

What is claimed is:

1. A connector for holding first and second rigid panels in a fixed relationship, said connector comprising:
a first segment of resilient material formed into two adjacent and concentric loops,
a second segment of resilient material formed into two adjacent and concentric loops, and
an interconnecting length of resilient material between said first and second segments for holding said segments in a fixed relationship,
wherein said first and second segments are each adapted to resiliently grasp a rigid panel and hold said panel in a fixed position between said adjacent loops.

2. The connector of claim 1 wherein said interconnecting member is bendable to allow changing the relative positions of said first and second segments.

3. The connector of claim 1 wherein said first and second segments are helical coils.

4. The connector of claim 2 wherein said first and second helical coils extend through an arc of at least 540°.

5. The connector of claim 1 wherein said interconnecting length of resilient material comprises an elongated stem.

6. The connector of claim 1 wherein said connector is formed from a single, continuous length of carbon steel wire.

7. The connector of claim 6 wherein said single, continuous length of carbon steel wire is coated with plastic.

8. The connector of claim 1 wherein said adjacent loops are circular.

9. A connector for use in crafts and hobbies for holding first and second rigid panels in a fixed, but modifiable, relationship, said connector comprising:
a first, helical coil of resilient material formed into two adjacent loops,
a second, helical coil of resilient material formed into two adjacent loops, and
an interconnecting length of bendable, resilient material between said first and second helical coils for holding said coils in a fixed, but modifiable, relationship, said relationship being modifiable by bending said interconnecting length of material,
wherein said first and second coils are each adapted to resiliently grasp a rigid panel and hold said panel in a fixed position between said adjacent loops.

10. The connector of claim 9 wherein said first and second coils each extends at least 540°.

11. The connector of claim 9 wherein said interconnecting length of resilient material comprises an elongated stem

12. The connector of claim 9 wherein said connector is formed from a single, continuous length of carbon steel wire.

13. The connector of claim 12 wherein said single, continuous length of carbon steel wire is coated with plastic.

14. The connector of claim 9 wherein said loops are circular.

15. A connector for use in crafts and hobbies for holding first and second rigid panels in a fixed relationship, said connector comprising
a first, helical coil of resilient material formed into two adjacent loops,
said first panel carried between said two adjacent loops of said first helical coil,
a second, helical coil of resilient material formed into two adjacent loops,
said second panel carried between said two adjacent loops of said second helical coil, and
an interconnecting length of resilient material between said first and second helical coils.

16. The apparatus of claim 15 wherein said interconnecting length of resilient material is bendable, whereby the angular orientation of said panels is adjustable.

17. The apparatus of claim 15 wherein said first and second panels are held at right angles to each other.

18. The apparatus of claim 15 wherein said first and second panels are held at an angle to each other and wherein an edge of said first panel is adjacent to an edge of said second panel.

19. The apparatus of claim 15 wherein said interconnecting length of material is an elongated stem and wherein said first and second panels are held in spaced apart, parallel planes.

20. The apparatus of claim 15 wherein more than two panels are connected by more than two of said connectors to build a structure or shape limited only by the creativity of the user.

21. A connector for holding n panels in a fixed relationship, said connector comprising:
n adjacent segments of resilient material each formed into two adjacent and concentric loops,
interconnecting lengths of resilient material between said adjacent segments for holding said segments in a fixed relationship,
wherein each of said n segments is each adapted to resiliently grasp and hold one of said n panels in a fixed position between each of said adjacent and concentric loops.
